(19) United States
(12) Patent Application Publication
(10) Pub. No.: US 2016/0275154 A1
(43) Pub. Date: Sep. 22, 2016

(54) EFFICIENT CALCULATIONS WITHIN A HIERARCHICALLY ORGANIZED DATA STRUCTURE

(71) Applicant: INFOTRAX SYSTEMS, OREM, UT (US)

(72) Inventors: Devry Anderson, Pleasant Grove, UT (US); Larry Nash, Provo, UT (US); Dan Floyd, West Jordan, UT (US); Mark Rawlins, Lehi, UT (US)

(21) Appl. No.: 15/071,058

(22) Filed: Mar. 15, 2016

Related U.S. Application Data
(60) Provisional application No. 62/133,774, filed on Mar. 16, 2015.

(51) Int. Cl. G06F 17/30

(52) U.S. Cl. CPC G06F 17/30554

(57) ABSTRACT

A server computer system can receive a database query comprising a request to return a calculated result based upon information stored in multiple entries within the hierarchically organized data structure. The server computer system accesses an ordered flat file database that comprises information stored within the hierarchically organized data structure. The information can include information associating each entry within the ordered flat file database with the entry's relative position within the hierarchically organized data structure. The server computer system can identify a first branch within the hierarchically organized data structure by reading the ordered flat file database progressively. The computer server system can then push one or more data entries upward within the first branch. Additionally, the computer system can identify a second branch within the hierarchically organized data structure by continuing to read the ordered flat file database progressively.

### CROSS-REFERENCE TO RELATED APPLICATIONS

This application claims the benefit of and priority to, U.S. Provisional Application Ser. No. 62/133,774, filed on Mar. 16, 2015, entitled “EFFICIENT CALCULATIONS WITHIN A HIERARCHICALLY ORGANIZED DATA STRUCTURE”. All of the aforementioned applications are incorporated by reference herein in their entirety.

### BACKGROUND OF THE INVENTION

1. Technical Field

The present invention relates generally to the technical characteristics and processing of a digital data structure.

2. Background and Relevant Art

Many businesses store hierarchically organized data in databases where any entry (or row) may be the parent of one or more child entries (or rows) within the database. A typical hierarchically organized database stores data in a relational database table. Although standard relational database access techniques can be used to access and process hierarchical data stored in this manner, these techniques can be slow especially when the hierarchical structure is large.

These slower techniques that have been used for accessing and processing hierarchical data have limited the number and type of real-time applications that consume the hierarchical data. In one example, multi-level marketing companies maintain hierarchical data structures representing the hierarchy of individuals participating in the multi-level marketing (“MLM”) scheme.

A typical hierarchical database will store many different pieces of data for each individual such as the total amount of sales for the individual in a specified period, a number of new customers obtained in a specified period, etc. One common computation performed on the hierarchical data is the calculation of commissions based on the total amount of sales for each individual. One individual's commission is generally based not only on the individual's sales, but the sales of other individuals under the individual in the hierarchy. In a large hierarchy, it may take a relatively long time to calculate the commission, or to calculate another figure that is dependent on the hierarchical relationships, for an individual. Additionally, in some cases, sales data may be stored within multiple independent hierarchies, requiring that data gathering and calculations be performed on multiple hierarchies, and requiring multiple requests directed towards each individual hierarchy.

For at least these and other reasons, many functions cannot be provided in real-time. Specifically, conventional databases make it difficult or impossible to provide or display certain real-time information such as commissions for individuals in a multi-level marketing organization, in particular, when data is split between multiple independent hierarchies. Accordingly, there are a number of disadvantages with organizational databases that can be addressed.

### BRIEF SUMMARY OF THE INVENTION

The present invention extends to methods, systems, and computer program products for calculating downline information within a hierarchical structure. In particular, implementations of the present invention generate an ordered flat file database that comprises the information stored within the hierarchical structure. Implementations of the present invention can then process queries directed towards the information stored within the ordered flat file database using various highly efficient methods and systems that are disclosed herein.

In one implementation, a server computer system can receive a database query comprising a request to return a calculated result based upon information stored in multiple entries within the hierarchically organized data structure. The server computer system accesses an ordered flat file database that comprises information stored within the hierarchically organized data structure. The information can include information associating each entry within the ordered flat file database with the entry's relative position within the hierarchically organized data structure. The server computer system can identify a first branch within the hierarchically organized data structure by reading the ordered flat file database progressively. The computer server system can then push one or more data entries upward within the first branch. Additionally, the computer system can identify a second branch within the hierarchically organized data structure by continuing to read the ordered flat file database progressively.

Additionally, a client computer console can identify a query of interest that is directed towards returning a calculated result based upon information stored in multiple entries within the hierarchically organized data structure. The client computer console can then submit the query of interest to a database system. The database system can comprise the hierarchically organized data structure stored within an ordered flat file database. Additionally, the client computer console can receive a query response to the query of interest.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a schematic of an exemplary computer environment in which an implementation of the present invention may be implemented;

FIG. 2 illustrates exemplary hierarchically organized data and an exemplary ordered flat file derived from the data, in accordance with an implementation of the present invention;

FIG. 3A illustrates an implementation of a calculation table generating a sum of values from within a portion of a hierarchical tree;

FIG. 3B illustrates an implementation of another calculation table generating a sum of values from within a portion of a hierarchical tree;

FIG. 3C illustrates an implementation of yet another calculation table generating a sum of values from within a portion of a hierarchical tree;

FIG. 4A illustrates an implementation of a memory block storing a calculated sum in accordance with the calculation table depicted in FIG. 3A;

FIG. 4B illustrates an implementation of a memory block storing a calculated sum in accordance with the calculation table depicted in FIG. 3B;

FIG. 4C illustrates an implementation of a memory block storing a calculated sum in accordance with the calculation table depicted in FIG. 3C;

FIG. 5 is a flowchart of an exemplary method implemented in accordance with one or more embodiments of the invention; and

FIG. 6 is a flowchart of another exemplary method implemented in accordance with one or more embodiments of the invention.

### DETAILED DESCRIPTION OF THE PREFERRED EMBODIMENTS

The present invention extends to methods, systems, and computer program products for calculating downline information within a hierarchical structure. In particular, implementations of the present invention generate an ordered flat file database that comprises the information stored within the hierarchical structure. Implementations of the present invention can then process queries directed towards the information stored within the ordered flat file database using various highly efficient methods and systems that are disclosed herein.

Accordingly, one or more implementations of the present invention can calculate cumulative information from a hierarchical data structure in a single pass through an ordered flat file. For example, a user can request a by-level summation of a particular data field for the entire structure. In at least one implementation, the by-level summation can be performed in a single pass through the data. Additionally, in at least one implementation, the by-level summation can be performed with limited writes to storage, such that calculation speed is minimally impacted by comparatively slow writes to storage.

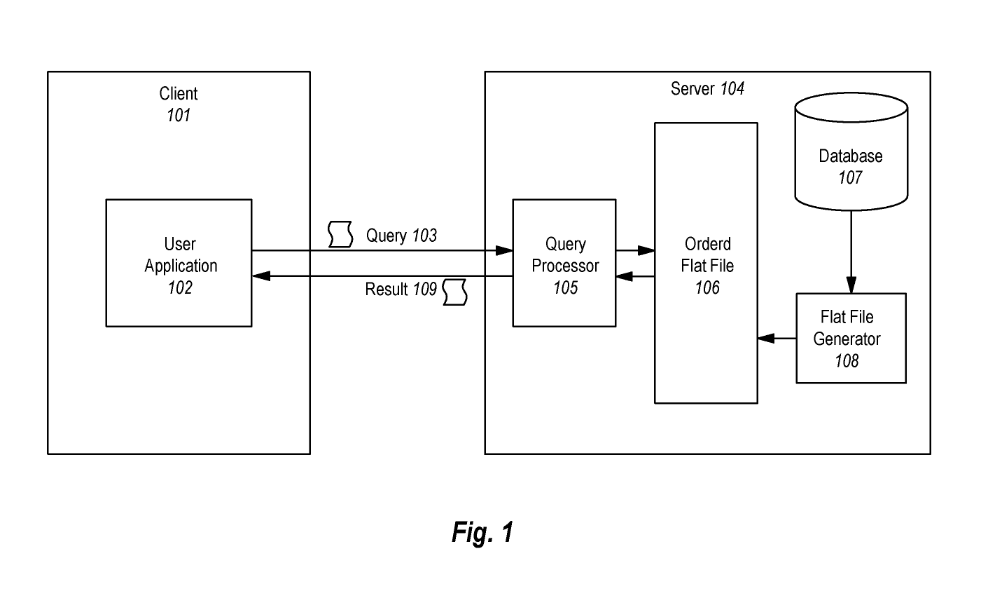

For example, FIG. 1 illustrates a generalized computer environment including a client 101 and a server 104 according to embodiments of the present invention. Client 101 may be any computer including a desktop, laptop, smart phone, etc. In at least one implementation, user application 102 on client 101 can comprise an application that sends queries to a remote computing device over a network, such as a server 104, which is configured for viewing hierarchical data stored in database 107. For example, user application 102 may be a general-purpose web browser, or may be a dedicated local or web-based application, which sends queries to a remote web server (e.g., server 104).

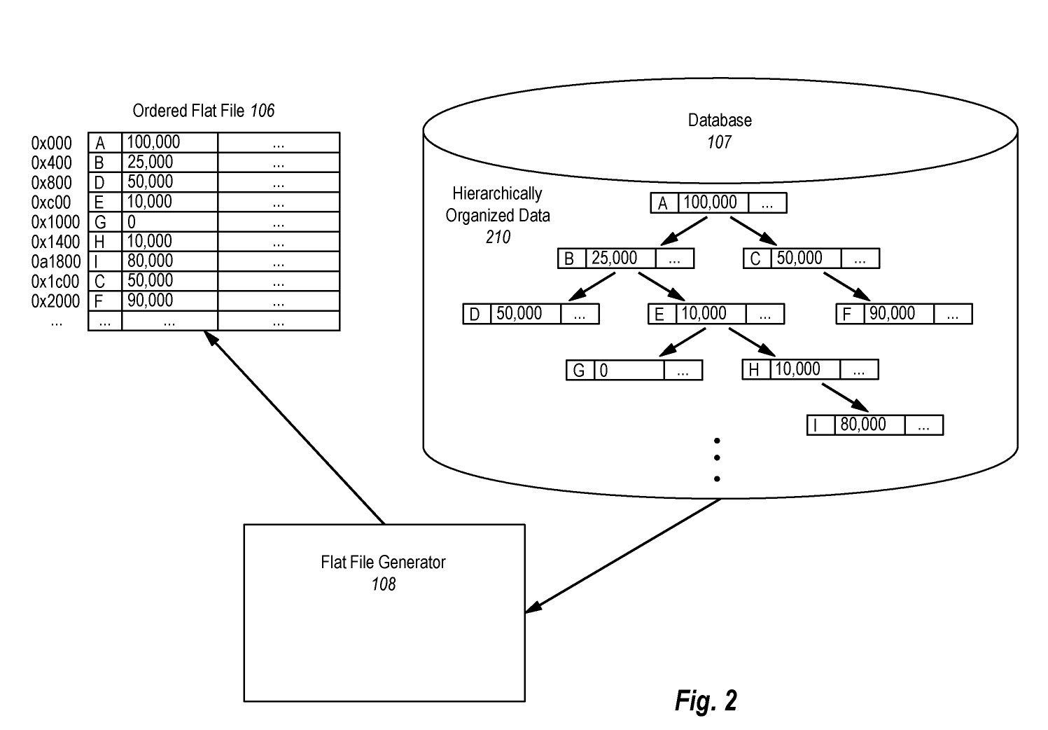

To expedite the processing of such queries, at least one implementation of the present invention can involve use of a flat file generator 108 on server 104 to create and maintain an ordered flat file 106. In at least one implementation, the ordered flat file 106 stores at least some of the hierarchical data of the database 107 as a flat file that maintains the hierarchical organization of the data, such as will be further described below with reference to FIG. 2. When the server 104 receives a query from a user application 102, the query processor 105 on server 104 can access the data fields and entries within the ordered flat file 106 to resolve the query rather than accessing the underlying data in database 107. In some implementations, after initially creating the flat file 106, the server 104 can delete the hierarchical data in the database 106.

FIG. 2 depicts a database 107, which stores exemplary hierarchically organized data 210. In particular, FIG. 2 shows that the hierarchically organized data 210 comprises a plurality of elements that each has at least one parent child relationship with another element. FIG. 2 also illustrates an exemplary ordered flat file 106 created from the hierarchically organized data 210 by flat file generator 108. In particular, FIG. 2 shows hierarchically organized data 210 as a tree structure for ease of illustration; however, one will appreciate that an ordered flat file can be created from an underlying database of any type or format (e.g., relational, flat file, etc.). The flat file generator 108 structures the ordered flat file 106 such that all direct descendants of an element are listed directly below the element within the flat file.

For example, because Element A is the base node and all other elements are descendants of Element A, the flat file generator 108 lists Element A first in the ordered flat file. Next, the flat file generator 108 lists Element B with all its direct descendants listed directly below it and prior to any other element that is at the same level or a higher level in the hierarchy than Element B. For example, FIG. 2 shows an implementation in which flat file generator 108 lists Element C (which is at the same level as Element B (i.e., a brother of Element B)) after all of Element B's direct descendants (elements D, E, G, H, and I).

FIG. 2 further depicts an implementation in which the various elements (A, B, D, E, . . . ) are directly adjacent to each other in memory. In at least one implementation, however, the elements are not necessarily next to each other in memory. Instead, in additional or alternative implementations, the various elements can be linked in the same order depicted in the ordered flat file 106 using pointers. For example, Element B can include a pointer to the memory location of Element D and Element A. Accordingly, Element B could identify that Element A is directly above it in the ordered flat file 106 and that Element D is directly below it. Alternatively, in at least one implementation, Element B can include a single pointer to either Element D or Element A, such that the ordered flat file 106 can only be traversed in a single direction.

As such, any element's descendants can be quickly determined by reading the ordered flat file 106 until an element with the same or higher level in the hierarchy is reached. For example, the query processor 105 can quickly determine that Element I does not have any descendants because the next element below Element I in the ordered flat file 106 is Element C, which is a brother to Element B, and is three levels higher than Element I in the hierarchy.

In at least one implementation, the query processor 105 can determine the level of an element within the hierarchy by accessing a hierarchical level data field (not shown) that comprises information relating to each element's relative level within the hierarchy. Additionally, in at least one implementation, the query processor 105 can determine the level of an element within the hierarchy by identifying each consecutive element's parent element. For example, when stepping from Element I to Element C within the order flat file 106, the query processor 105 can identify that Element C's parent element is Element A, and not Element I. As such, the query processor 105 can determine that Element C is the start of a new branch off of Element A.

The listed fields in the ordered flat file 106 of FIG. 2 represent the element's name (or identifier) and a total sales amount for the person represented by the element. However, an ordered flat file can include any number of fields storing any type of data as indicated by the ellipses. For example, each element in the ordered flat file 106 may include a field that defines the element's level in the hierarchy, as well as other fields containing data that may be used to calculate reports. The ordered flat file 106 of FIG. 2 depicts elements that are 1 KB in size as represented by the hexadecimal addresses to the left of each element. However, the server 104 may allocate any size to elements in the hierarchy. In at least one embodiment, however, the server 104 allocates the same size to each element.

One will appreciate in view of the specification and claims herein that an ordered flat file can be particularly beneficial in representing a “downline” of an individual in a hierarchical organization, such as a multi-level marketing business structure. An individual's “downline” in a multi-level marketing hierarchy refers to the individual and all other individuals that fall below the individual in the hierarchy. Using the example of FIG. 1, Element B's downline would include Elements D, E, G, H, and I (but not C, F). Thus, a system can quickly determine B's downline by sequentially reading the ordered flat file from Element B to Element I, and stopping at Elements C and F.

Generally, it is faster to access hierarchical data stored in an ordered flat file than it is to access the same data stored in an underlying database. Therefore, calculations based on hierarchical data, such as commissions as previously described, can be performed more quickly by creating an ordered flat file of the hierarchical data, and accessing the hierarchical data within the ordered flat file to generate the required result set.

The flat file generator 108 may create an ordered flat file from a hierarchical dataset stored in an underlying database at various times. For example, a multi-level marketing business may update its database with sales figures at the end of each business day. After the updates are entered each day, a complete ordered flat file may be generated to represent the state of the hierarchical data. Of course, an ordered flat file may be created at any interval. Additionally, in at least one embodiment, an existing flat file can be updated to reflect new information by individually accessing and updating each required data field. For example, the query processor 105 can add a new element to an ordered flat file 106 by updating one or more pointers to include the new element at the correct location within the file.

Generally, a query for data of a hierarchical dataset causes the server to request a sub-portion of the hierarchical dataset. One example includes a query for an individual's downline. As described above, the sub-portion of hierarchical data can be obtained when, for example, the query processor reads a sequential portion of the ordered flat. To locate the beginning of the sequential portion to be read, the query processor will need to identify an initial or starting element. For example, to locate the beginning of Element B's downline, the query processor 105 will need to identify Element B in the ordered flat file.

In general, the system can take at least two approaches to locate the beginning of the sequential portion: “sequential access,” and “random access.” Sequential access refers to reading from the beginning of the ordered flat file, and continuing to read the elements in the ordered flat file until the first element of the sequential portion is identified. Once the query processor 105 identifies the first element, any permissions (i.e., filtering conditions) in the query can be applied to the elements in the portion as the elements are read.

Random access, on the other hand, refers to reading an element of the ordered flat file without first reading the preceding elements in the ordered flat file. Random access can be accomplished by maintaining a location index for each element in the ordered flat file. Reading the element's location within the index and then accessing the ordered flat file at the address provided by the index can determine an element's location in the ordered flat file. In at least one implementation, the index and/or the flat file can be addressed using a hash map.

In either sequential or random access, once the first element of the sequential portion is identified, the query processor 105 can quickly retrieve the remaining elements of the sequential portion by sequentially reading the ordered flat file until an element that is at the same or higher level in the hierarchy is identified at which point no further reads need to be performed. As each element in the sequential portion is read, the query processor 105 can apply the filtering condition to generate one or more result sets. In other words, the query processor 105 need only perform a single pass of the ordered flat file to identify the relevant portion and to apply the permissions to the portion to generate one or more result sets.

As described above, implementations of the present invention provide methods and systems for quickly accessing data elements from within hierarchical tree structures. In addition to the ability to quickly access the data element, in at least one implementation, the query processor 105 can quickly and efficiently perform various calculations generating cumulative and by-level data. For instance, the query processor 105 can calculate the cumulative sales of an entire hierarchical sales structure, while at that same time calculating the cumulative sales below each respective salesperson within the hierarchy.

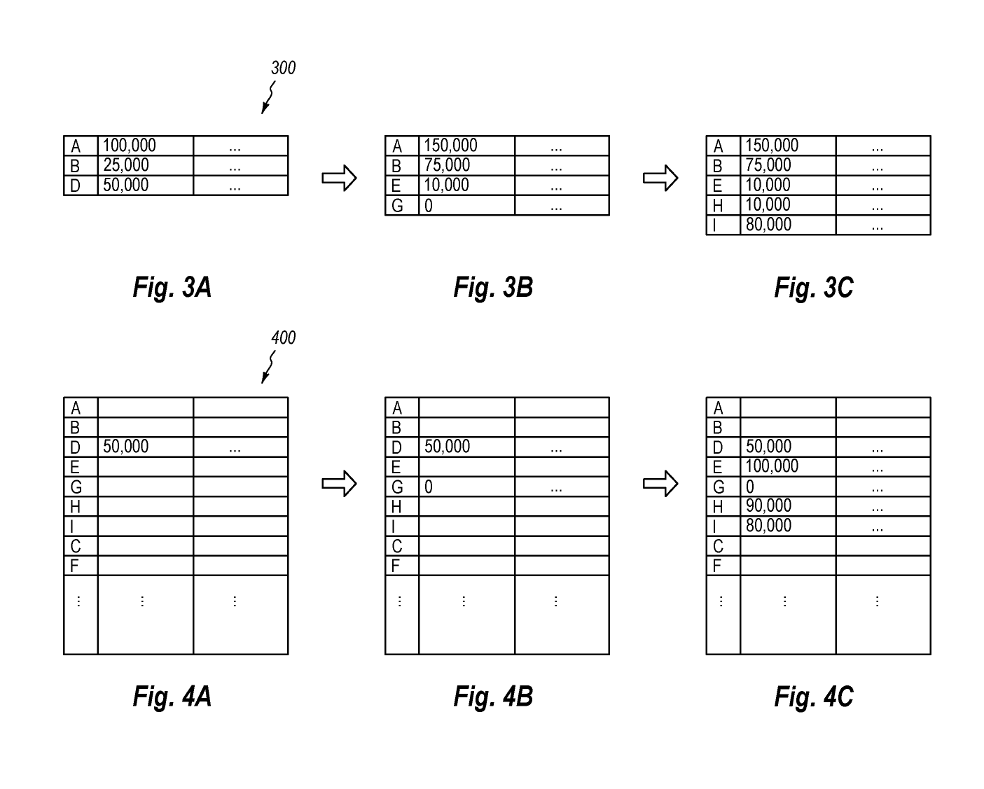

For example, FIGS. 3A-4C depict various steps in an implementation for calculating gross sales within an exemplary MLM company. In particular, FIGS. 3A-4C depict a gross sales amount being calculated for each node, relative to each node's downline. As one will understand, in some MLM companies, an organization will pay an individual based not just upon his or her own sales, but also based upon the sales of other salespersons who are enrolled within the individual's downline. FIGS. 3A-4C depict various steps in an implementation of a method for determining the amount of gross sales with which a system credits each individual within an MLM hierarchy.

FIGS. 3A through 3C depict various implementations of a calculation table. In at least one implementation, a calculation table comprises a portion of high-speed memory that is used to perform calculations, which high-speed memory may or may not be structured as a literal table. The high-speed memory can comprise random access memory within server 104. Though depicted sequentially in FIG. 3A, the actual calculation table 300 may not comprise an actual logical structure, but instead, may simply comprise temporary memory locations used for quickly performing calculations. Additionally, while the present implementation focuses specifically upon the calculation of gross sales, in at least one implementation, the query processor 105 and the calculation table 300 can be used to simultaneously calculate multiple data points (e.g., gross sales for period, rate of sales increase, expenses, etc.) in a single pass of the order flat file 106.

Turning now to FIG. 3A, upon receiving a query 103 to return a by-level gross sales for each node within a hierarchical tree, the query processor 105 can access the ordered flat file 106. In particular, the query processor 105 can begin to sequentially write the contents of the ordered flat file 106 into a calculation table 300. For example, FIG. 3A shows that the query processor 105 has written data relating to Element A, Element B, and Element D into the calculation table 300. As used herein, each element may be equivalent to a node in the hierarchically organized data 210.

As the query processor 105 sequentially steps through the ordered flat file 106, the query processor 105 can identify individual nodes that do not link to any respective children nodes. For example, upon reaching Element D, the query processor 105 can determine that Element D is the last element in its respective sub-branch. Once the end of a sub-branch is reached, the query processor 105 can being to calculate the requested data by “pushing” numbers up the calculation table.

For instance, in FIG. 3A, Element A is associated with $100,000 of individual gross sales, Element B is associated with $25,000 of individual gross sales, and Element D is associated with $50,000 of gross sales. Upon reaching Element D, and determining that Element D is the end of a sub-branch, the query processor 105 can cumulate the $50,000 associated with Element D upward. As such and as depicted in FIG. 3B, Element B is now associated with $75,000 of gross sales and Element A is associated with $150,000 of gross sales. In at least one implementation, the query processor 105 can determine that Element D is the end of the sub-branch by determining that the next element within the ordered flat file 106, Element E, comprises a hierarchical level equal to or greater than the hierarchical level of at least one of the elements already in the calculation table (Element A and Element B).

While the depicted implementation shows the $50,000 for Element D being “pushed” to the top of the ordered flat file 106 (i.e. to Element A), in at least on implementation, the query processor 105 only pushes the value up until the next fork in the hierarchically organized data 210 is reached. For example, the $50,000 may only be pushed up to Element B, because Element B comprises a second sub-branch that has not been cumulated yet. In at least one implementation, the query processor 105 can determine how far a number should be pushed up the ordered flat file 106 by identifying the parent of the next node within the ordered flat file 106. For example, upon reaching Element D and determining the Element D is the last node in the particular sub-branch, the query processor 105 can identify the parent of the next node in the ordered flat file 106. In this case, the next node is Element E. The query processor 105 can determine that Element B is the parent to Element E, and using this information the query processor 105 can push the numbers up until it reaches Element B.

Once the query processor 105 has finished pushing numbers up the calculation table, the query processor 105 can write the calculations associated with Element D to storage and delete Element D and its associated numbers from the calculation table 300. For example, FIG. 4A depicts an implementation of a memory block 400 that comprises storage for the various final results of the calculation. The memory block 400 comprises a memory portion for Element D and for the various calculated results associated with Element D, including the $50,000 cumulative gross sales.

In at least one implementation, the query processor 105 can write to storage every element that is of an equal or lower hierarchical level than the next element in the order flat file 106. For example, Element E, the next element in the order flat file 106 after Element D, is of the same level as Element D. As such, the query processor 105 can write to storage Element D. In an alternative implementation, Element D may have a child element, Element X. Element E would still be the subsequent element in the order flat file 106. Upon determining the Element E was higher in hierarchical level than Element X and equal in hierarchical level to Element D, the query processor 105 can write both Element D and Element X to the storage device.

In at least one implementation, the memory block 400 comprises a physical non-transitory storage space, a hard drive, flash memory, a digital cassette, or some other storage type. One will understand that in many modern computer systems writing to storage is a relatively slow process that can significantly impact the performance of a given system. Accordingly, in at least one implementation of the present system, values are only written to storage after the value has been completely calculated. As such, the number and frequency of writes to storage are minimized.

Returning now to the Figures, FIG. 3B depicts the calculation table subsequent to deleting Element D. Specifically, FIG. 3B shows an instance in which the query processor 105 has continued to step down the ordered flat file 106. Accordingly, the query processor 105 has written to the calculation table the values for both Element E and Element G. Upon reaching Element G, the query processor 105 can determine that Element G is the final node in a respective sub-branch.

Because Element G is associated with $0 of gross sales, in at least one implementation, the query processor 105 will not push any value up, but will instead simply erase Element G and its associated data from the calculation table 300. In the case the Element G has non-zero data in one of its associated fields of interest, however, the query processor 105 can push the data up the calculation table as discussed above.

FIG. 4B depicts the memory block of FIG. 4A, now including an entry for Element G. As depicted, even though Element G is associated with a zero value, in at least one implementation, the query processor 105 may still write the zero value to the storage device.

After writing the value for Element G to the proper memory block 400, the query processor 105 can continue to step down the order flat file 106. Accordingly, the query processor can write Element H and Element I to the calculation table 300 depicted in FIG. 3C. The query processor 105 can then determine that Element I is the last node within its respective sub-branch. As such, the query processor 105 can push the values from Element I up the calculation table 300.

In the depicted implementation, pushing the values associated with Element I up the calculation table 300 comprises adding $80,000 to each of the respective elements within the calculation table (i.e., Element H, Element E, Element B, and Element A). The query processor 105 can then erase Element I and its associated data from the calculation table 300 and write the values associated with Element I to the storage devices. For example, FIG. 4C depicts Element I and its associated data written to a portion of memory block 400.

Returning to FIG. 3C, the query processor 105 can determine that Element H is part of the same branch as Element I and that Element H has no children other than Element I. As such, the query processor 105 can push the $10,000 value associated with Element H up the calculation table. The query processor 105 can then erase Element H and write its associated data to a storage device. For example, FIG. 4C depicts Element H and its associated data (including the cumulative gross sales data received from Element I) written to a memory block 400.

Returning again to FIG. 3C, the query processor 105 can determine that Element E is part of the same branch as Element H and that Element E has no children other than Element G and Element H, both of which have already been written to storage. As such, the query processor 105 can push the values associated with Element E up the calculation table. The query processor 105 can then erase Element E and write its associated data to a storage device. For example, FIG. 4C depicts Element E and its associated data (including the cumulative gross sales data received from Element G, Element H, and Element I) written to a memory block 400.

One will understand that the above described process can continue until the desired data is gathered. While the above example deals with a simple summation of a particular field within a hierarchical tree, in various alternate implementations, complex math can occur at each step between the calculation table and the storage of the end results to the memory block. For example, data from different levels within the hierarchical data structure can be weighted based upon their level within the structure. Additionally, complex calculations involving derivatives, integrals, and statistical analysis can be performed in a similar function where the data is gathered within a single pass through the ordered flat file 106 and results are stored to a memory block as sufficient data is gathered to perform each calculation.

Accordingly, in at least one implementation of the present invention, the query processor 105 can calculate multiple by-level calculations in a single pass through the ordered flat file 106. This allows the query processor 105 to make highly efficient use of storage by only writing values that are completely calculated to the storage device. As such, implementations of the present invention provide a highly efficient system for calculating data from a hierarchical data structure.

In at least one implementation, an individual that is associated with a particular element within the hierarchical structure can generate a query. For example, in at least one implementation, the hierarchical structure can represent salespeople within an MLM company. A particular salesperson can be represented by an element within the hierarchical structure, for example, Element B.

Additionally, the salesperson can submit a query 103 to the server 104 requesting information relating to the MLM. In at least one implementation, when performing the methods disclosed above, the query processor 105 can restrict the information that is provided to the salesperson based upon permissions that are associated with the salesperson. Further, in at least one implementation, the salesperson's permissions may be relative to the salesperson's location within the hierarchical data structure 210. For example, the permissions may only allow the query processor 105 to return information to the salesperson that originates with a specific number of hierarchical levels from the salesperson. As such, implementations of the present invention can efficiently generate calculations from a hierarchical structure, while at the same time limiting the amount of information that individuals can access.

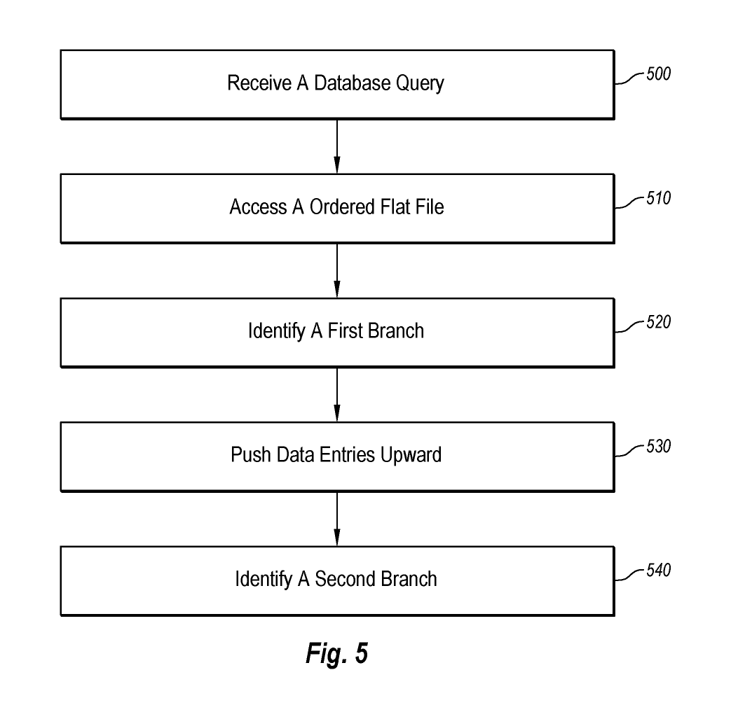

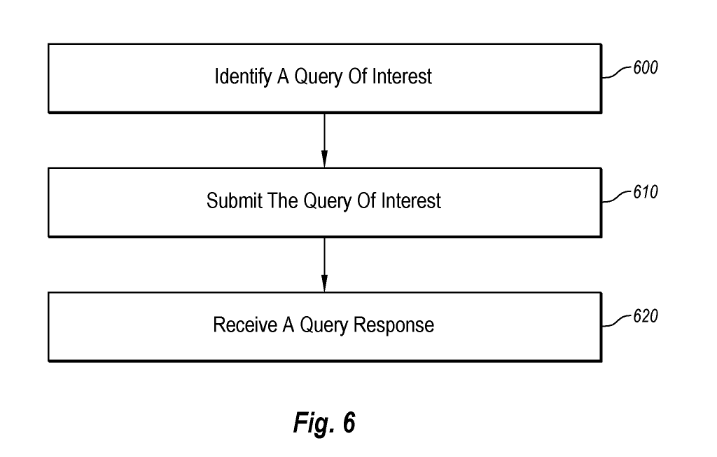

Accordingly, FIGS. 1-4C and the corresponding text illustrate or otherwise describe one or more methods, systems, and/or instructions stored on a storage medium that can quickly and efficiently perform by-level calculations in a single pass of an ordered flat file. One will appreciate that implementations of the present invention can also be described in terms of methods comprising one or more acts for accomplishing a particular result. For example, FIGS. 5 and 6 and the corresponding text illustrate flowcharts of a sequence of acts in a method for calculating downline information relative to a hierarchically organized data structure. The acts of FIGS. 5 and 6 are described below with reference to the components and modules illustrated in FIGS. 1-4C.

For example, FIG. 5 illustrates that an implementation of a method for calculating downline information relative to a hierarchically organized data structure can comprise an act 500 of receiving a database query. Act 500 includes receiving a database query comprising a request to return a calculated result based upon information stored in multiple entries within the hierarchically organized data structure. For example, in FIG. 1 and the accompanying description, query 103 is directed towards returning information that is stored within various entries within the hierarchically organized data structure.

FIG. 5 also shows that the method can comprise an act 510 of accessing an order flat file. Act 510 includes accessing an ordered flat file database. The ordered flat file database can comprise information stored within the hierarchically organized data structure, including information associating each entry within the ordered flat file database with the entry's relative position within the hierarchically organized data structure. For example, FIG. 2 and the accompanying description, depict or otherwise describe an ordered flat file 106 and associated hierarchically organized data 210 are depicted, which the server can then access to satisfy a query. The various elements within the ordered flat file 106 are linked and ordered in such a way that the hierarchically data structure can be recreated from the ordered flat file 106.

Additionally, FIG. 5 shows that the method can comprise an act 520 of identifying a first branch. Act 520 can include identifying a first branch within the hierarchically organized data structure by reading the ordered flat file database progressively. For example, in FIG. 3A and the accompanying description, the query processor 105 identifies that Element D (see also FIG. 2) comprises an end point of a first branch (i.e., stemming from parent Element B).

Further, FIG. 5 shows that the method can comprise an act 530 of pushing data entries upward. Act 530 includes pushing one or more calculated results upward within the first branch. For example, FIGS. 3A and 4A, and the accompanying descriptions, describe the query processor 105 “pushing up” the calculated results by cumulating the $50,000 associated with Element D with the respective values of Element B and Element A. As used within this application, “data entries” can comprise previously stored information, calculated information, numerical information, non-numerical information, and/or any other database storable information.

Further still, FIG. 5 shows that the method can comprise an act 540 of identifying a second branch. Act 540 can include identifying a second branch within the hierarchically organized data structure by continuing to read the ordered flat file database progressively. For example, FIG. 3B and the accompanying description describe the query processor 105 identifying that Element G is an end point of a second branch (i.e., from parent Elements B, E).

In an additional implementation of the present invention, FIG. 6 illustrates that a method for requesting and receiving calculated data from a hierarchical database can comprise an act 600 of identifying a query of interest. Act 600 includes identifying a query of interest, wherein the query of interest is directed towards returning a calculated result based upon information stored in multiple entries within the hierarchically organized data structure. For example, FIG. 1 depicts a query processor 105 receiving a query 103 that is directed towards returning information from a database 107. FIG. 2 further depicts that the database 107 can comprise hierarchically organized data 210.

Additionally, FIG. 6 shows that the method can comprise an act 610 of submitting the query of interest. Act 610 can include submitting the query of interest to a database system, wherein the database system comprises the hierarchically organized data structure stored within an ordered flat file database. For example, FIG. 1 depicts a query processor 105 submitting a query 103 to an ordered flat file 106.

Further, FIG. 6 shows that the method can comprise an act 620 of receiving a query response. Act 620 can include receiving a query response to the query of interest. For example, FIG. 1 depicts the query processor 105 returning a result 109 to a user application 102.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A computer system for calculating downline information relative to a hierarchically organized data structure, comprising:
one or more processors; and
one or more computer-readable media having stored thereon executable instructions that when executed by the one or more processors configure the computer system to perform at least the following:
receive a database query comprising a request to return a calculated result based upon information stored in multiple entries within the hierarchically organized data structure;
access an ordered flat file database, wherein the ordered flat file database comprises information stored within the hierarchically organized data structure, including information associating each entry within the ordered flat file database with the entry's relative position within the hierarchically organized data structure;
identify a first branch within the hierarchically organized data structure by reading the ordered flat file database progressively;
push one or more data entries upward within the first branch; and
identify a second branch within the hierarchically organized data structure by continuing to read the ordered flat file database progressively.

2. The system as recited in claim Error! Reference source not found., wherein pushing the one or more data entries upward within the first branch comprises:
creating a calculation table that comprises a first group of sequential data entries from the ordered flat file database, wherein each of the data entries within the group is from a unique and progressively lower level of the hierarchically organized data structure;
identifying that a subsequent entry, which is immediately adjacent to the first group of sequential data entries within the ordered flat file, is at a level equal to or greater than a level within the hierarchically organized data structure associated with an entry that is currently within the first group of sequential data entries from the ordered flat file; and
writing to a storage medium one or more calculated results that are associated with entries within the calculation table that are at a level within the hierarchically organized data structure equal to or lower than the level within the hierarchically organized data structure associated with the subsequent entry.

3. The system as recited in claim 2, wherein the sequential data entries comprise individual entries that are each at a respectively lower level in the hierarchically organized data structure than each entry's immediate parent entry.

4. The system as recited in claim 2, wherein the executable instructions include instructions that when executed configure the computer system to:
after identifying that the subsequent entry from within the ordered flat file is at a level equal to or greater than a level within the hierarchically organized data structure associated with an entry that is currently within the first group of sequential data entries from the ordered flat file, calculate a result associated with a particular entry within the calculation table using information from other entries within the calculation table that are at a level within the hierarchically organized data structure equal to or lower than both: (i) the level within the hierarchically organized data structure associated with the subsequent entry, and (ii) a level within the hierarchically organized data structure associated with the particular entry.

5. The system as recited in claim 4, wherein the first branch comprises the entries within the calculation table that are at the level within the hierarchically organized data structure equal to or lower than the level associated with the subsequent entry.

6. The system as recited in claim 2, wherein each of the one or more calculated results is only written to the storage medium after being completely calculated.

7. The system as recited in claim Error! Reference source not found., wherein pushing one or more data entries upward within the first branch comprises cumulating information associated with at least one entry within the first branch with information associated with one or more other entries within the first branch.

8. The system as recited in claim Error! Reference source not found., wherein the first branch and the second branch comprise one or more of the same entries.

9. The system as recited in claim Error! Reference source not found., wherein the calculated result is determined in a single pass of the ordered flat file database.

10. A computer system for requesting and receiving calculated data, comprising:
one or more processors; and
one or more computer-readable media having stored thereon executable instructions that when executed by the one or more processors configure the computer system to perform at least the following:
identify a query of interest, wherein the query of interest is directed towards returning a calculated result based upon information stored in multiple entries within the hierarchically organized data structure;
submit the query of interest to a database system, wherein the database system comprises the hierarchically organized data structure stored within an ordered flat file database; and
receive from the database system a query response to the query of interest.

11. The system as recited in claim 10, wherein the ordered flat file database comprises information stored within the hierarchically organized data structure, including information associating each entry within the ordered flat file database with the entry's relative position within the hierarchically organized data structure.

12. The system as recited in claim 10, wherein the query of interest comprises a request for an accumulation of by-level information relative to a particular entry within the hierarchically organized data structure.

13. The system as recited in claim 12, wherein the query of interest comprises a request for an accumulation of by-level information relative to a plurality of different entries within the hierarchically organized data structure.

14. The system as recited in claim 13, wherein the query response is generated by a single pass through the ordered flat file database.

15. The system as recited in claim 10, wherein the query response comprises an accumulation of by-level information relative to a particular entry within the hierarchically organized data structure.

16. The system as recited in claim 10, wherein the query of interest originates from a requestor, which requestor is associated with a specific entry within the hierarchically organized data structure.

17. The system as recited in claim 16, wherein the executable instructions include instructions that when executed configure the computer system to:
filter the query response based upon the location of the specific entry within the hierarchically organized data structure.

18. The system as recited in claim 10, wherein the query of interest is further directed towards returning a calculated result based upon information stored in a particular branch within the hierarchically organized data structure.

19. A method, implemented at a computer system that includes one or more processors, for calculating downline information relative to a hierarchically organized data structure, the method comprising:
receiving a database query comprising a request to return a calculated result based upon information stored in multiple entries within the hierarchically organized data structure;
accessing an ordered flat file database, wherein the ordered flat file database comprises information stored within the hierarchically organized data structure, including information associating each entry within the ordered flat file database with the entry's relative position within the hierarchically organized data structure;
identifying a first branch within the hierarchically organized data structure by reading the ordered flat file database progressively;
pushing one or more data entries upward within the first branch; and
identifying a second branch within the hierarchically organized data structure by continuing to read the ordered flat file database progressively.

20. The method as recited in claim 19, wherein pushing the one or more data entries upward within the first branch comprises:
creating a calculation table that comprises a first group of sequential data entries from the ordered flat file database, wherein each of the data entries within the group is from a unique and progressively lower level of the hierarchically organized data structure;
identifying that a subsequent entry, which is immediately adjacent to the first group of sequential data entries within the ordered flat file, is at a level equal to or greater than a level within the hierarchically organized data structure associated with an entry that is currently within the first group of sequential data entries from the ordered flat file; and
writing to a storage medium one or more calculated results that are associated with entries within the calculation table that are at a level within the hierarchically organized data structure equal to or lower than the level within the hierarchically organized data structure associated with the subsequent entry.
